(19) United States
(12) Patent Application Publication
(10) Pub. No.: US 2012/0212983 A1
(43) Pub. Date: Aug. 23, 2012

(54) METHOD FOR CONVERTING POWER FOR A HIGH-VOLTAGE DIRECT VOLTAGE CONNECTION

(75) Inventor: Dejan Schreiber, Nurnberg (DE)

(73) Assignee: Semikron GmbH & Co., KG, German corporation, Nurnberg (DE)

(21) Appl. No.: 13/355,568

(22) Filed: Jan. 23, 2012

Related U.S. Application Data
(62) Division of application No. 11/825,336, filed on Jul. 6, 2007, now abandoned.

(30) Foreign Application Priority Data
Jul. 8, 2006 (DE) 10 2006 031 662.2

(51) Int. Cl. H02M 5/458

(52) U.S. Cl. 363/37

(57) ABSTRACT

A method for converting a multi-phase alternating voltage into a high-voltage direct voltage and then into a second multi-phase alternating voltage. The method utilizes first and second cascades of power converter cells, with each individual cell having respective first and second current valves. The method includes offsetting the clocking of individual power converter cells by a predetermined factor; cyclically switching off the first current valves in counterpoint with the second current valves, so that only one set of current valves are “on” at any given time while the other set of current valves is “off” at that time; and, in response to a signal indicating that an individual power cell is malfunctioning, shunting out the individual malfunctioning power cell.

### Cross-reference to Related Applications

This application is a divisional application of prior-filed and co-pending application Ser. No. 11/825,336, filed Jul. 6, 2007.

### BACKGROUND OF THE INVENTION

1. Field of the Invention

The invention is directed to a power converter circuit for converting a first, three-phase alternating voltage from a plurality of sources into a high-voltage direct voltage for transmission to a high-voltage direct voltage connection, and for further converting the voltage into a further three-phase alternating voltage. Such high-voltage direct voltage connections are used for instance in wind power plants; wherein, the output power and the output voltage of the generators both vary dynamically. When a plurality of wind power plants are arranged as so-called wind farms in the prior art, the individual wind power plants are connected to a high-voltage direct voltage connection by a common power inverter that serves to feed current into an electrical power system.

2. Description of the Related Art

In the prior art, three phase alternating current generators of the medium-voltage category are commonly used. The three phases of the outputs of these generators are connected to a transformer, which transforms the medium voltage into a high voltage on the order of magnitude of 100,000 volts. This alternating voltage generated is then rectified by means of a high-voltage diode rectifier and fed into a high-voltage direct voltage connection.

Following the high-voltage direct voltage connection, the direct voltage is converted by means of a power inverter into a suitable alternating voltage and fed into an electrical power system. Such high-voltage direct voltage connections are known in the form of “HVDC” or “HVDC light” technology made by ABB.

It is a particular disadvantage of such prior art systems that the input filters are extremely expensive. In this respect, power inverters are known that are embodied as a serial arrangement of a multiplicity of bipolar transistors of special construction and with special connections. A disadvantage of this prior art is that with this embodiment of the rectifier, all the transistors are switched simultaneously, and very large voltage changes per unit of time occur in the lines. To control these voltage changes, correspondingly large filters and also special, complicated and expensive intermediate circuit capacitors are necessary. The effort and expense in terms of circuitry, for instance in the form of these high-voltage capacitors, and for simultaneously switching all the transistors is a disadvantage.

German Patent DE 101 14 075 B4 discloses a power converter comprising a rectifier circuit for converting an alternating current, generated in an alternating voltage generator, into a direct current, a direct current connection from the rectifier circuit to a cascaded power inverter, a downstream medium-voltage transformer for feeding a high-voltage power system, and a primary controller. The power inverter comprises a cascaded, serial arrangement of a plurality of power inverter cells, whose inputs are connected in series, and each of these power inverter cells can be switched by the overriding controller to be active or, by shunting their inputs, to be inactive.

### SUMMARY OF THE INVENTION

The object of the present invention is to provide a power converter circuit for converting a first alternating voltage into a high-voltage direct voltage and, after suitable transmission, to convert that voltage into a second alternating voltage, in which the power converter circuit is meant to be error-tolerant with regard to the failure of individual semiconductor switches; the changes in voltage per unit of time should also be reduced considerably compared to the prior art, and the construction should be possible using standard power semiconductor modules.

A power converter circuit in accordance with the invention serves to convert at least a first multi-phase alternating voltage into a high-voltage direct voltage. The multi-phase alternating voltage may for instance be generated by a plurality of generators in the context of a decentralized energy supply, as in a wind farm. The power converter likewise serves to convert this high-voltage direct voltage into a second multi-phase alternating voltage for feeding into an electrical power system, such as a medium-voltage power system.

The power converter of the invention comprises first and second cascades of power converter cells.

The first cascade is formed of a serial arrangement of first power converter cells, and the second cascade is formed of a serial arrangement of second power converter cells.

Every other power converter cell has first terminals on the transformer side and second terminals on the direct voltage side. The first terminals serve to connect the associated windings of a transformer to the respective center points of a three-phase bridge circuit. This bridge circuit in turn is connected to an intermediate circuit, which in at least one branch has a second current valve and, connected parallel to the three-phase bridge circuit, a first current valve. This current valve is connected to the first terminals of the power converter cell.

The first power converter cells are either identical to the second power converter cells or have a three-phase rectifier circuit, whose respective center points are connected to the associated windings of a transformer. The second terminals, on the direct voltage side, are likewise suitably connected to the three-phase rectifier circuit.

The aforementioned cascades are embodied as a serial connection of the second terminals of adjacent power converter cells.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

The concept of the invention is described below with reference to preferred embodiments of the invention, in conjunction with FIGS. 1 and 2.

FIG. 1 shows a first embodiment of a power converter circuit arrangement of the invention.

FIG. 2 shows a second embodiment of the power converter circuit arrangement of the invention.

### DETAILED DESCRIPTION OF THE PREFERRED EMBODIMENTS

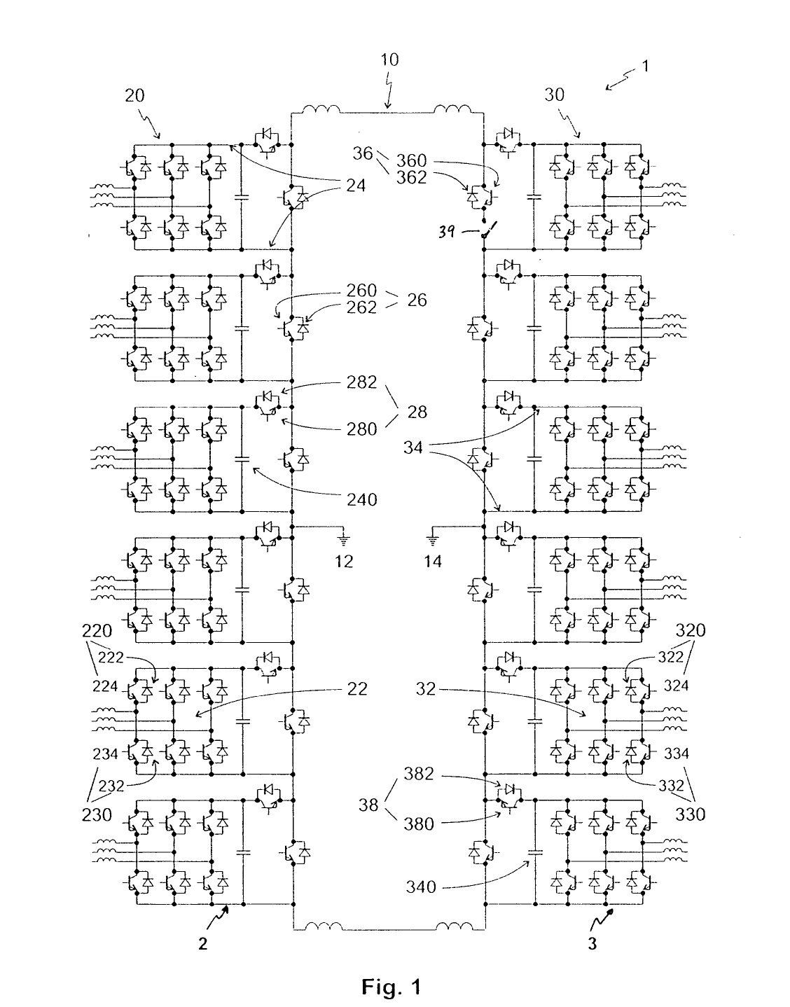

FIG. 1 shows a first embodiment of a power converter circuit 1 according to the invention. What is shown here is a fully symmetrical embodiment, not taking the embodiment of the transformers, which are not shown, into account.

Each power converter 20, 30 comprises a three-phase bridge circuit 22, 32 (respectively), which is embodied in turn with one upper power switch 220, 320 (respectively) and one lower power switch 230, 330 (respectively) per phase. Each power switch 220, 230, 320, 330 in turn comprises a parallel circuit of a plurality of bipolar transistors 224, 234, 324, 334 (respectively), only one of each of which is labeled. Connected antiparallel to these transistors 224, 234, 324, 334 is a plurality of free-wheeling diodes 222, 232, 322, 332 (respectively), and once again only one of each is labeled. The transistors and diodes are for instance semiconductor components with a rating of 1700 V, of the kind used in manifold ways in standard power semiconductor modules. The direct voltage side of the three-phase bridge circuit 22, 32 is connected to an intermediate circuit 24, 34 (respectively), which has at least one capacitor 240, 340. The alternating voltage side of each three-phase bridge circuit 22, 32 is connected centrally to a respective associated winding of a transformer.

A first current valve 26, 36 is connected parallel to three-phase bridge circuit 22, 32 (respectively) and to capacitors 240, 340 (respectively), respectively. In this embodiment of power converter circuit 1, first current valve 26, 36 is embodied as an antiparallel circuit of at least one bipolar transistor 260, 360 and at least one diode 262, 362. First current valve 26, 36 serves to shunt out the respective power converter cell 20, 30. Thus, on the one hand a cascade 2, 3 with a redundant number of power converter cells 20, 30 can be embodied. On the other hand, a defective power converter can be shunted out, and therefore the functionality of the entire power converter circuit 1 can be preserved even if a failure occurs in any individual component.

Intermediate circuit 24, 34 also, in one branch, has a second current valve 28, 38, which is likewise embodied as an antiparallel circuit of at least one bipolar transistor 280, 380 and at least one diode 282, 382.

In the embodiment shown of power converter circuit 1, cascades 2, 3 are formed of six power converter cells 20, 30 each, but this is merely an example. A high-voltage direct current transmitter operates for instance with a voltage of 100 kV, for which purpose, depending on the voltage ratings of the semiconductor components used, the number of serially connected power converter cells 20, 30 is on the order of magnitude of 100.

In such an embodiment of the power converter circuit 1, it is advantageous for insulation regions to connect each cascade 2, 3 at its center point to ground potential 12, 14. Thus the high-voltage direct current transmitter 10, with a voltage of 100 kV, for example, is advantageously connected at its center point to ground potential, and as a result the potential of the individual line toward ground amounts to only 50 kV each, making its insulation simpler.

A further advantage of this embodiment of the power converter circuit 1 is that by means of offset clocking of the individual power converter cells 20, 30, the voltage changes per unit of time are substantially lower in comparison to the prior art discussed above. As a result, the input filters still needed can be substantially less complicated.

It is also advantageous that in the embodiment of the power converter circuit 1 of the invention, as a result of offset clocking of the individual power converter cells 20, 30, the current ripple in the power system is less, compared to the prior art, by a factor that corresponds to the number of power converter cells 20, 30. At a clock frequency of 1 kHz, for instance, and an offset of 0.1 ms, the current ripple in the power system is equivalent to a virtual switching frequency of 10 kHz.

In this symmetrical embodiment of the power converter circuit 1, energy can be transmitted in both directions, that is, from first cascade 2 to second cascade 3, but also from second cascade 3 to first cascade 2. In transmission from first cascade 2 to second cascade 3, all the transistors 260 of first current valve 26 are switched to be nonconducting; thus only the current path via diodes 262 is conducting. The various transistors 280 of second current valve 28 of those power converter cells that are to be added are in this case made conducting. By this kind of addition of power converter cells 20, the generated direct voltage of first cascade 2 is increased, or upon subtraction is reduced.

Transistors 380 of second current valves 38 of second cascade 3 are all switched to be nonconducting, and as a result only the current path through diode 382 is conducting. Depending on the direct voltage transmitted, transistors 380 of first current valve 36 are made conducting. By cyclical switching of these transistors 360, all the power converter cells 30 are may be loaded uniformly. It is equally possible for individual defective cells to be fundamentally switched off. This purpose can also be served by an additional mechanical switch 39.

Cells capable of functioning that are switched off can furthermore provide a necessary reactive power for the alternating voltage power system connected, and this reactive power can have arbitrary capacitive or inductive components.

The power converter circuit 1 of the invention, because of its cascaded construction comprising cascades 2, 3 of power converter cells 20, 30 with standard components, has the advantage that even high-voltage direct current transmitters for small outputs, for instance from 1 MW up, can be produced economically. The scalable construction thus has the advantage that the effort and expense are also scaled approximately linearly with the power. This makes the economical use of high-voltage direct current transmitters between asynchronous separate power systems, for instance, possible.

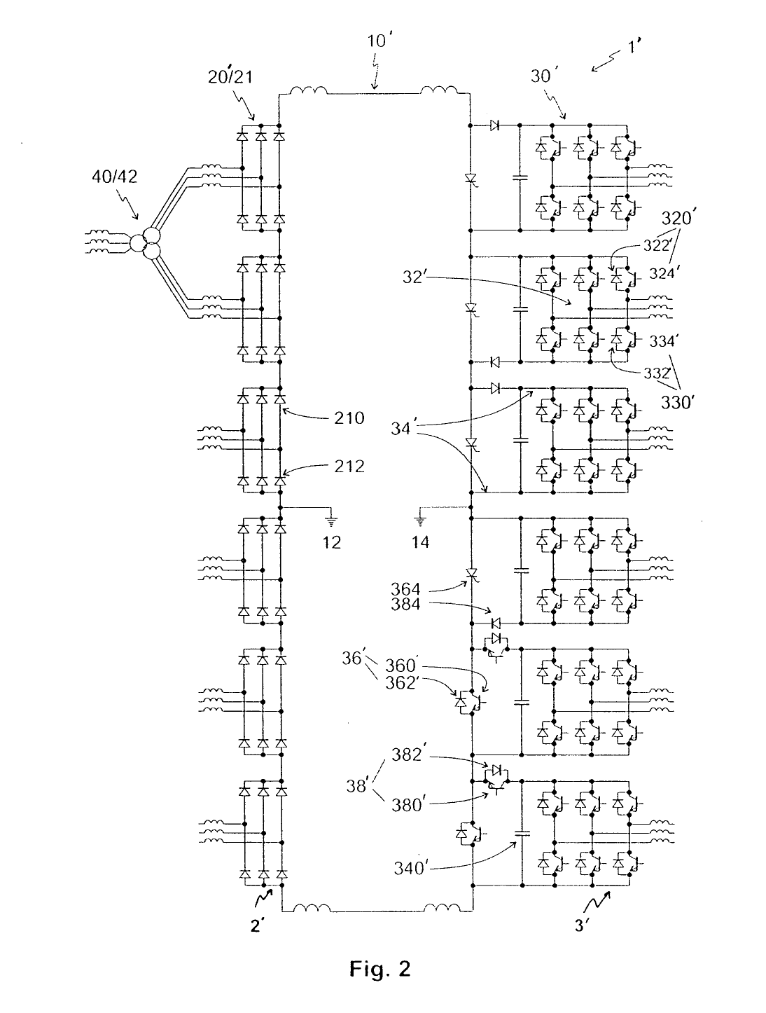

FIG. 2 shows a second exemplary embodiment of a power converter circuit 1′ of the invention. In this case, an asymmetrical embodiment is shown, with first power converter cells that are embodied as rectifiers and second power converter cells whose fundamental embodiment is equivalent to the power converter cells of FIG. 1.

Each first power converter cell 20′ comprises a three-phase rectifier circuit 21, each having one upper current valve 210 and one lower current valve 212 per phase; each current valve 210, 212 is embodied as a diode, or preferably as a plurality of parallel-connected diodes, for example with a rating of 1700 V, and as a result standard power semiconductor modules can be used as components of cascade 2′.

The direct voltage side of three-phase rectifier circuit 21 forms second terminals on the direct voltage side, while the alternating voltage side is connected, in each case centrally, to an associated winding 42 of transformer 40.

In this respect, it is especially advantageous if the first terminals, on the transformer side, of two adjacent first power converter cells 20 are each connected to respective associated windings 42 of a transformer 40.

Second power converter cells 30′ of power converter circuit 1′ are embodied in two different embodiments. In each embodiment, second power converter cell 30′ comprises a three-phase bridge circuit 32′, which in turn is embodied with one upper power switch 320′ and one lower power switch 330′ per phase. Each power switch 320′, 330′ in turn comprises a parallel circuit of a plurality of bipolar transistors 324′, 334′, only one of each of which is labeled. A free wheeling diode 322′, 332′ is connected antiparallel to each of transistors 324′, 334′ respectively, and once again only one of each is labeled. The transistors and diodes here are for instance a semiconductor component with a rating of 1700 V, of the kind used in manifold ways in standard power semiconductor modules. The direct voltage side of three-phase bridge circuit 32′ is connected to an intermediate circuit 34′, which has at least one capacitor 340′. The alternating voltage side of the three-phase bridge circuit 32′ is connected, in each case centrally, to an associated winding of a transformer, not shown.

A first current valve 36′ is connected parallel to three-phase bridge circuit 32′ and to capacitor 340′. Current valve 36′, in the first embodiment of second power converter cells 30′, is embodied as an antiparallel circuit of at least one bipolar transistor 360′ and at least one diode 362′. This current valve 36′ serves to shunt out the respective power converter cell 30′. Thus, on the one hand, a cascade 3′ with a redundant number of power converter cells 30′ can be embodied. On the other hand, a defective power converter cell can thus be shunted out, and hence the functionality of the entire power converter circuit 1′ can be preserved even if individual component failures occur.

Intermediate circuit 34′ moreover, in one branch, has a second current valve 38′, which is likewise embodied as an antiparallel circuit of at least one bipolar transistor 380′ and at least one diode 382′.

In the second embodiment of second power converter cells 30′, the second current valve 38′ includes at least one diode 384. If there is a plurality of such diodes, then they are understood to be connected in parallel. First current valve 36′ is embodied as a thyristor 364.

In the embodiment shown of power converter circuit 1′, cascades 2′, 3′ are once again formed of six power converter cells 20′, 30′ each, and this is again merely an example, for the sake of simplicity. The precise number is determined by the voltage of the high-voltage direct current transmitter 10′, the voltage categories of the power semiconductor components used, and the desired redundance in terms of power converter cells 20′, 30′. One of ordinary skill in the art would recognize the appropriate number of components to be used in any given application without undue experimentation.

In such an embodiment of power converter circuit 1′, it is advantageous for insulation reasons to connect each cascade at its center point to ground potential 12, 14.

In this asymmetrical embodiment of the power converter circuit 1′, energy can be transmitted solely from first cascade 2′ to second cascade 3′.

The connection to an associated transformer 40 is shown, taking two first power converter cells 20′ as an example. It is especially advantageous that the first terminals, on the transformer side, of two adjacent power converter cells 20′ are each connected to respective associated windings 42 of transformer 40.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for converting at least one multi-phase alternating voltage, received by a plurality of individual power converter cells, each individual power converter cell having first and second current valves, into a high-voltage direct voltage and for converting that high-voltage direct voltage into a second multi-phase alternating voltage, the method comprising:
offsetting the clocking of individual power converter cells by a predetermined factor;
cyclically switching off said first current valves in counterpoint with said second current valves, so that only one set of current valves, either said first current valves or said second current valves are “on” at any given time while the other of said first and second current valves is “off” at that time;
in response to a signal indicating that an individual power cell is malfunctioning, shunting out said individual malfunctioning power cell.

2. The method of claim 1, wherein said first current valve comprises a series of antiparallel circuits, one of said circuits being associated with each power cell, and being configured to allow the shunting out of said malfunctioning power cell.

3. The method of claim 1, wherein said predetermined factor is a function of the number of power cells.
